(19) United States
(12) Patent Application Publication
(10) Pub. No.: US 2019/0105636 A1
(43) Pub. Date: Apr. 11, 2019

(54) PLATINUM GROUP METAL CATALYSTS SUPPORTED ON LARGE PORE ALUMINA SUPPORT

(71) Applicant: BASF Corporation, Florham Park, NJ (US)

(72) Inventors: Xiaoming Wang, Basking Ridge, NJ (US); Michel Deeba, East Brunswick, NJ (US)

(73) Assignee: BASF Corporation, Florham Park, NJ (US)

(21) Appl. No.: 16/094,646

(22) PCT Filed: Feb. 28, 2017
(86) PCT No.: PCT/US17/19808

§ 371 Date: Oct. 18, 2018

Related U.S. Application Data
(60) Provisional application No. 62/326,141, filed on Apr. 22, 2016.

(51) Int. Cl. B01J 23/44; B01J 23/42; B01J 23/46; B01J 21/04; B01J 37/02; F01N 3/10; F01N 3/28

(52) U.S. Cl. CPC B01J 23/44; B01J 23/42; B01J 23/464; B01J 21/04; B01J 37/0201; F01N 3/0222; F01N 3/281; F01N 3/2828; F01N 2330/06; F01N 2330/02; F01N 2330/32; F01N 3/101

(57) ABSTRACT

The present disclosure provides a three-way conversion (TWC) catalyst composition suitable for at least partial conversion of gaseous hydrocarbons (HC), carbon monoxide (CO), and nitrogen oxides (NOx). Generally, the catalyst composition comprises a platinum group metal component impregnated into a porous refractory oxide support, wherein the porous refractory oxide support has an average pore radius ranging from about 250 Å to about 5,000 Å, a total intrusion volume of at least about 1.8 ml/g, and a porosity of at least about 80%.

### FIELD OF THE INVENTION

The present invention relates generally to the field of three-way conversion catalysts and their use in emission gas treatment systems to reduce hydrocarbons, carbon monoxide, and nitrogen oxides.

### BACKGROUND OF THE INVENTION

Various catalysts have been developed for purifying the exhaust gas emitted from internal combustion engines by reducing harmful components contained in the exhaust gas such as hydrocarbons (HC), nitrogen oxides (NOx) and carbon monoxide (CO).

These catalysts are usually part of an exhaust gas treatment system, which may further comprise catalytic converters, evaporative emissions devices, scrubbing devices (e.g., hydrocarbon, sulfur, and the like), particulate filters, traps, adsorbers, absorbers, non-thermal plasma reactors, and the like, as well as combinations comprising at least one of the foregoing devices. Each of these devices individually or in combination may be rated in terms of their ability to reduce the concentration of any one of the harmful component(s) in an exhaust gas stream under various conditions.

Catalytic converters, for example, are one type of an exhaust emission control device used with an exhaust gas treatment system, and comprise one or more catalytic materials disposed on a substrate. The composition of the catalytic materials, the composition of the substrate, and the method by which the catalytic material is disposed on the substrate serve as one way in which catalytic converters are differentiated from one another.

For example, catalyst composites of catalytic converters often comprise a platinum group metal (PGM) dispersed onto one or more refractory metal oxide supports. Typically, these catalyst composites are known for their use in treating the exhaust gas stream of internal combustion engines to reduce nitrogen oxides (NOx), hydrocarbons (HC) and carbon monoxide (CO) gaseous pollutants. These catalyst composites are called three-way conversion catalysts (TWC). Typically, these catalyst composites are formed on ceramic or metallic substrate carriers (such as the flow-through honeycomb monolith carrier, as described herein below) upon which one or more catalyst coating compositions are deposited.

For example, palladium (Pd) is commonly impregnated into a refractory metal oxide support such as alumina. TWC catalyst composites using Pd-supported alumina are often used in the treatment of exhaust gas emissions resulting from gasoline and diesel internal combustion engines. However, these supports suffer from a lack of hydrothermal stability.

With emissions regulations become more stringent, there is a continuous need to develop catalyst composites with improved catalytic performance and stability.

### SUMMARY OF THE INVENTION

The present invention provides a three-way conversion (TWC) catalyst composition suitable for at least partial conversion of gaseous hydrocarbons (HC), carbon monoxide (CO), and nitrogen oxides (NOx). The TWC catalyst composition includes a PGM component impregnated into a porous refractory oxide support and may optionally include the same PGM component impregnated into an oxygen storage component (OSC). Unlike porous refractory oxide supports currently used in TWC catalyst compositions, the porous refractory oxide support of the invention exhibit a porosity of at least 80%, a total intrusion volume of at least 1.8 ml/g, and an average pore radius ranging from about 250 Å to about 5,000 Å. It is the combination of these properties (i.e., high porosity, high intrusion volume, and average pore radius), which contribute to the efficient catalytic conversion of HC, CO, and NOx when using the TWC catalyst composition of the invention. In addition, improved physical properties of such TWC catalyst compositions have also been observed, which include hydrothermal stability, PGM dispersion, and mass transfer properties.

One aspect of the invention is directed to a catalyst composition comprising a platinum group metal component impregnated into a porous refractory oxide support, wherein the porous refractory oxide support has an average pore radius ranging from about 250 Å to about 5,000 Å, a total intrusion volume is at least about 1.8 ml/g, and a porosity of at least about 80% based on the total volume.

In some embodiments, the porous refractory oxide support has a total pore area of at least about 50 m²/g (e.g., measured by mercury porosimetry).

In some embodiments, a platinum group metal is impregnated into an oxygen storage component. In another embodiment, the platinum group metal component is palladium. In one embodiment, the porous refractory oxide support is alumina. In certain embodiments, the alumina support can be modified or stabilized with additional metal oxides, such as oxides of La, Mg, Ba, Sr, Zr, Ti, Si, Ce, Mn, Nd, Pr, Sm, Nb, W, Mo, Fe, or combinations thereof. In some embodiments, the platinum group metal component is a combination of palladium and platinum, wherein the platinum is present in about 10% to about 80% by weight of the total platinum group metal component. For example, in some embodiments the platinum is present in about 20% to about 60% by weight of the total platinum group metal component.

In some embodiments, the porous refractory oxide support comprises at least 90% by weight alumina based on the total weight of the porous refractory oxide support. In some embodiments the porous refractory oxide support comprises stabilized alumina.

In another embodiment, the oxygen storage component comprises ceria. In one embodiments, the oxygen storage component is a ceria-zirconia composite. In another embodiment, the ceria-zirconia composite comprises at least 10% by weight ceria, based on the total weight of the oxygen storage component.

Another aspect of the invention is directed to a catalyst article comprising a catalyst substrate having a plurality of channels adapted for gas flow, each channel having a coating dispersed therein, the coating comprising the catalyst composition according to present invention. In one embodiment, the catalyst substrate is a metal or ceramic honeycomb. In another embodiment, the honeycomb comprises a wall flow filter substrate or a flow through substrate.

In another embodiment, the catalyst composition is applied to the substrate with a loading of at least about 1.0 g/in³.

In some embodiments, the coating comprises a first layer comprising a first catalyst component in the form of the catalyst composition according to any of the preceding claims, optionally in combination with an additional catalyst component selected from the group consisting of a second PGM component impregnated into a second refractory oxide support, a base metal oxide, or a combination thereof, and a second layer comprising rhodium impregnated on a third refractory oxide support. In some embodiments, at least one layer comprises a loading of PGM component impregnated into a porous refractory oxide component ranging from about 0.25 to about 1.5 g/in³. In some embodiments, in the first catalyst component, the PGM component is palladium and the porous refractory oxide support comprises alumina. In another embodiment, the second layer further comprises a PGM component impregnated on an OSC.

In some embodiments at least one of the first and second layers is zoned into an upstream zone and a downstream zone. In some embodiments, the downstream zone comprises one or more of a base metal oxide and a PGM component impregnated on an OSC. IN another embodiment the total PGM loading onto the catalyst substrate ranges from about 10 to about 200 g/ft³.

Another aspect of the invention is directed to a method for reducing CO, HC, and NOx levels in an exhaust gas comprising contacting the gas with a catalyst for a time and temperature sufficient to reduce the levels of HC, CO, and NOx in the gas. In one embodiment, the CO, HC, and NOx levels present in the exhaust gas stream are reduced by at least 50% compared to the CO, HC, and NOx levels in exhaust gas stream prior to contact with the catalyst.

Another aspect of the invention is directed to a method of making a catalyst article comprising:
impregnating a porous refractory oxide support with a salt of a platinum group metal component to form a platinum group metal (PGM) impregnated porous refractory oxide support;
calcining PGM impregnated porous refractory oxide support;
preparing a slurry by mixing the PGM impregnated porous refractory oxide support in an aqueous solution;
coating the slurry onto a monolithic substrate (e.g., such as a metal or ceramic honeycomb substrate); and
calcining the coated monolithic substrate to obtain the catalyst article.

In one embodiment, the method further comprises impregnating an oxygen storage component with a salt of a platinum group metal component to form a platinum group metal (PGM) impregnated oxygen storage component. In one embodiment, the platinum group metal (PGM) impregnated oxygen storage component was calcined. In another embodiment, the PGM is palladium and the refractory oxide support comprises alumina.

In one embodiment, the PGM component is palladium, such as embodiments wherein the total amount of palladium deposited on the monolithic substrate is from about 10 to about 200 g/ft³. In some embodiments, the PGM component is a combination of Pd and Pt, such as in a weight ratio of about 20:1 to about 1:1 of Pd to Pt. In certain embodiments, the total amount of Pd and Pt deposited on the monolithic substrate is from about 10 to about 200 g/ft³, and in particular embodiments, the Pt represents about 5-50% by weight of total PGM content.

The PGM on porous alumina can be in any of the catalyst layers present on the substrate, such as in an amount of about 0.25-1.5 g/in³. The PGM on porous alumina (e.g., Pd on porous alumina) can be located in any layered or zone configuration, such as wherein the Pd on the porous alumina is located in a front portion of the coated substrate in a zoned catalyst coating. Still further, the Pd on porous alumina can mixed with other Pd/porous support materials, such as other refractory oxides (e.g., lower porosity alumina, Pr—ZrO₂, La—ZrO₂, and the like) supporting Pd or other PGM components.

In another embodiment, the catalyst article is disposed downstream from an internal combustion engine. In another embodiment, the internal combustion engine is a gasoline or diesel engine.

### BRIEF DESCRIPTION OF THE DRAWINGS

In order to provide an understanding of embodiments of the invention, reference is made to the appended drawings, which are not necessarily drawn to scale, and in which reference numerals refer to components of exemplary embodiments of the invention. The drawings are exemplary only, and should not be construed as limiting the invention.

FIG. 1 is a perspective view of a honeycomb-type substrate carrier which may comprise a catalyst article (i.e., three-way conversion (TWC) catalyst) coating composition in accordance with the present invention;

FIG. 2 is a partial cross-sectional view enlarged relative to FIG. 1 and taken along a plane parallel to the end faces of the substrate carrier of FIG. 1, which shows an enlarged view of a plurality of the gas flow passages shown in FIG. 1, in an embodiment wherein the substrate is a monolithic flow-through substrate; and

FIG. 3 is a cutaway view of a section enlarged relative to FIG. 1, wherein the honeycomb-type substrate carrier in FIG. 1 represents a wall flow filter substrate monolith.

FIG. 4 is a representation of a coated standard three way conversion (TWC) catalyst having a combination of a first PGM (PGM₁) impregnated refractory oxide support (ROS), a PGM impregnated oxygen storage component (OSC), and base metal oxide(s) (BMO) in the first (bottom) layer and a second PGM (PGM₂) impregnated ROS in the second (top) layer, wherein the first PGM impregnated refractory oxide support (ROS) in the first layer is not the same as the second PGM impregnated refractory oxide support (ROS) in the second layer;

FIG. 5 is a representation of a coated standard three way conversion (TWC) catalyst having a combination of a first PGM (PGM₁) impregnated refractory oxide support (ROS), a PGM impregnated oxygen storage component (OSC), and base metal oxide(s) (BMO) in the first (bottom) layer and a combination of the first PGM (PGM₁) impregnated ROS and a second PGM (PGM₂) impregnated ROS in the second (top) layer, wherein the first PGM impregnated ROS is not the same as the second PGM impregnated ROS;

FIG. 6 is a representation of a coated standard three way conversion (TWC) catalyst having a first PGM (PGM₁) impregnated refractory oxide support (ROS) in the first (bottom) layer and a combination of a second PGM (PGM₂) impregnated ROS, a PGM impregnated OSC, and base metal oxide(s) in the second (top) layer;

FIG. 7 is a representation of a zoned three way conversion (TWC) catalyst having a first PGM (PGM₁) impregnated ROS in first (bottom) layer and a zoned second (top) layer; wherein a second PGM (PGM₂) impregnated ROS is in the upstream zone and a combination of the second PGM (PGM₂) impregnated ROS, PGM impregnated OSC, and base metal oxide(s) (BMO) is in the downstream zone;

FIG. 8 is a representation of a zoned three way conversion (TWC) catalyst having a zoned first (bottom) layer of a first PGM (PGM₁) impregnated ROS in the upstream zone and a combination of the first PGM (PGM₁) impregnated ROS, a PGM impregnated OSC, and base metal oxide(s) in the downstream zone, and a second PGM (PGM₂) impregnated into ROS in the second (top) layer;

FIG. 9 is a representation of a three way conversion (TWC) catalyst having a combination of a first PGM (PGM₁) impregnated refractory oxide support (ROS) and base metal oxide(s) (BMO) in the first (bottom) layer and a combination of a second PGM (PGM₂) impregnated ROS and a PGM impregnated OSC in the second (top) layer;

FIG. 10 is a representation of a three way conversion (TWC) catalyst having a combination of a first PGM (PGM₁) impregnated refractory oxide support (ROS) and a PGM impregnated oxygen storage component (OSC) in the first (bottom) layer and a combination of a second PGM (PGM₂) impregnated ROS and base metal oxide(s) (BMO) in the second (top) layer;

FIG. 11 is a line graph showing the Log differential intrusion volume (mL/g) as a function of pore size radius (angstroms) obtained from mercury porosimetry experiments; and

FIG. 12 is a line graph showing an expansion of the x-axis of FIG. 12, wherein the x-axis shows a range from about 10 to about 10,000 angstroms.

### DETAILED DESCRIPTION OF THE PREFERRED EMBODIMENTS

The present invention now will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art. As used in this specification and the claims, the singular forms “a,” “an,” and “the” include plural referents unless the context clearly dictates otherwise.

The present invention describes a three-way conversion (TWC) catalyst composition suitable for at least partial conversion of gaseous hydrocarbons (HC), carbon monoxide (CO), and nitrogen oxides (NOx). The TWC catalyst composition includes a PGM component impregnated into a porous refractory oxide support and may optionally include the same PGM component impregnated into an oxygen storage component. The porous refractory oxide support used in the current invention exhibits a porosity of at least 80%, an average pore radius ranging from about 250 Å to about 1,000 Å, and a total intrusion volume of at least 1.8 ml/g. Although many refractory oxide supports can be considered “porous”, it is the combination of high porosity, average pore radius, and high intrusion volume of such refractory oxide supports, which contribute to the efficient catalytic conversion of HC, CO, and NOx. In addition, TWC catalyst compositions including such porous refractory oxide supports also exhibit improved physical properties over TWC catalyst compositions currently in use such as hydrothermal stability, PGM dispersion, and mass transfer properties.

The following terms shall have, for the purposes of this application, the respective meanings set forth below.

As used herein, the term “catalyst” or “catalyst composition” refers to a material that promotes a reaction. As used herein, the phrase “catalyst system” refers to a combination of two or more catalysts, for example a combination of a first catalyst and a second catalyst. The catalyst system may be in the form of a coating in which the two catalysts are mixed together.

As used herein, the terms “upstream” and “downstream” refer to relative directions according to the flow of an engine exhaust gas stream from an engine towards a tailpipe, with the engine in an upstream location and the tailpipe and any pollution abatement articles such as filters and catalysts being downstream from the engine.

As used herein, the term “stream” broadly refers to any combination of flowing gas that may contain solid or liquid particulate matter. The term “gaseous stream” or “exhaust gas stream” means a stream of gaseous constituents, such as the exhaust of a lean burn engine, which may contain entrained non-gaseous components such as liquid droplets, solid particulates, and the like. The exhaust gas stream of a lean burn engine typically further comprises combustion products, products of incomplete combustion, oxides of nitrogen, combustible and/or carbonaceous particulate matter (soot), and un-reacted oxygen and nitrogen.

As used herein, the term “substrate” refers to the monolithic material onto which the catalyst composition is placed, typically in the form of a coating containing a plurality of particles containing a catalytic composition thereon. A coating s formed by preparing a slurry containing a certain solid content (e.g., 30-90% by weight) of particles in a liquid vehicle, which is then coated onto a substrate and dried to provide a washcoat layer, i.e., coating.

As used herein, the term “washcoat” has its usual meaning in the art of a thin, adherent coating of a catalytic or other material applied to a substrate material, such as a honeycomb-type carrier member, which is sufficiently porous to permit the passage of the gas stream being treated.

As used herein, the term “catalyst article” refers to an element that is used to promote a desired reaction. For example, a catalyst article may comprise a coating containing catalytic compositions on a substrate. The catalyst article may be “fresh” meaning it is new and has not been exposed to any heat or thermal stress for a prolonged period of time. “Fresh” may also mean that the catalyst was recently prepared and has not been exposed to any exhaust gases. Likewise, an “aged” catalyst article is not new and has been exposed to exhaust gases and/or elevated temperature (i.e. greater than 500° C.) for a prolonged period of time (i.e., greater than 3 hours).

As used herein, the term “impregnated” or “impregnation” refers to permeation of the catalytic material into the porous structure of the support material.

### Catalyst Composition

The catalyst composition includes a PGM component impregnated into a porous refractory oxide support (ROS). The catalyst composition may further comprise a second PGM component impregnated into an oxygen storage component (OSC) or a refractory oxide support (ROS). As used herein, “platinum group metal” or “PGM” refers to platinum group metals or oxides thereof, including platinum (Pt), palladium (Pd), ruthenium (Ru), rhodium (Rh), iridium (Ir), and mixtures thereof. In certain embodiments, the PGM components in each support are the same. In some embodiments, the PGM components in each support are different. In one embodiment, the PGM component impregnated into the porous refractory oxide support and the PGM component impregnated into the oxygen storage component are Pd. In one or more embodiments, the individual PGM components comprise a combination of platinum group metals, e.g., platinum and palladium, such as in a weight ratio of about 0.1:10 to about 10:0.1, preferably of about 0.1:2 to about 1:1. In other embodiments, the individual PGM components include platinum or palladium. In some embodiments, the individual PGM component includes Rh. The concentrations of each PGM component (e.g., Pt, Pd, Rh or a combination thereof) can vary, but will typically be from about 0.1 wt. % to about 10 wt. % relative to the weight of the impregnated porous refractory oxide support or the oxygen storage component (e.g., about 1 wt. % to about 6 wt. % relative to the impregnated support material).

In some embodiments, the catalyst composition comprises a combination of a PGM component impregnated into a porous refractory oxide support and the same PGM component impregnated into an oxygen storage component, such that the amount of PGM component (e.g., Pd) impregnated into a refractory oxide component present in the catalyst composition is in the range of about 1 to about 10 times, preferably about 1 to about 5 times the weight of the PGM component (e.g., Pd) impregnated into an oxygen storage component present in the catalyst composition.

In some embodiments, the catalyst composition further comprises a base metal oxide(s) (i.e., BMO) mixed with a PGM impregnated refractory oxide material or a PGM impregnated OSC. Any base metal(s) known in the art can be used, e.g., BaO, SrO, La₂O₃, and combinations thereof (e.g., BaO—ZrO₂).

As used herein, “porous refractory oxide” refers to porous metal-containing oxide support exhibiting chemical and physical stability at high temperatures, such as the temperatures associated with Gasoline and Diesel engine exhaust. Exemplary porous refractory oxides include alumina, silica, zirconia, titania, ceria, and physical mixtures or chemical combinations thereof, including atomically-doped combinations and including high surface area or activated compounds such as activated alumina. In some embodiments, alumina is modified with a metal oxide(s) of alkali, semimetal, and/or transition metal, e.g., La, Mg, Ba, Sr, Zr, Ti, Si, Ce, Mn, Nd, Pr, Sm, Nb, W, Mo, Fe, or combinations thereof. In some embodiments, the surface of the alumina is primarily modified with metal oxide(s) thereby changing the catalytic properties of alumina (e.g., changes in catalytic sites available). In some embodiments, the amount of metal oxide(s) used to modify the alumina can range from about 0.5% to about 10% by weight based on the amount of alumina. In some embodiments, the amount of alumina in such refractory oxide support is at least 90% by weight based on the total amount the porous refractory oxide support.

In some embodiments, refractory oxides modified with ceria ranging in an amount of about 5% to about 75% by weight based on the amount of refractory oxide material.

Exemplary combinations of metal oxides include alumina-zirconia, ceria-zirconia, alumina-ceria-zirconia, lanthana-alumina, lanthana-zirconia, lanthana-zirconia-alumina, baria-alumina, baria lanthana-alumina, baria lanthana-neodymia alumina, and alumina-ceria. In some embodiments, exemplary metal oxide supports for Rh include alumina, zirconia-alumina, lanthana-zirconia, zirconia, ceria-zirconia. Exemplary aluminas include large pore boehmite, gamma-alumina, and delta/theta alumina. Useful commercial aluminas include activated aluminas, such as high bulk density gamma-alumina, low or medium bulk density large pore gamma-alumina, and low bulk density large pore boehmite and gamma-alumina, including stabilized oxides.

In some embodiments, the alumina is modified using a “stabilizer” such as a metal oxide(s) of alkali, semimetal, and/or transition metal, e.g., La, Ba, Sr, Zr, Ti, Si, Mg, or combinations thereof, which are able to increase the thermal stability of to the unmodified aluminum oxide. Unfortunately, when unmodified γ-aluminum oxide is heated to high temperatures, the structure of the atoms within the crystal lattice collapses over time causing the surface area to decrease substantially and as a result the catalytic activity of the catalyst compositions containing γ-aluminum oxide decreases as well. Therefore, if a stabilized aluminum oxide is used, preferably up to about 40 weight percent (wt %) stabilizer may be employed, based on the total weight of the stabilized aluminum oxide with about 2 wt. % to about 30 wt. % stabilizer preferred, and about 4 wt. % to about 10 wt. % stabilizer more preferred. Examples of such an aluminum oxide component may include a lanthanide (La) stabilized gamma aluminum oxide (referred to herein as La γ-aluminum oxide), a theta-aluminum oxide (referred to herein as θ-aluminum oxide), a barium (Ba) stabilized gamma aluminum oxide, (referred to herein as Ba-γ-aluminum oxide), or a combination comprising at least one of the foregoing aluminum oxides.

As mentioned previously, each refractory oxide support may have a porosity associated with it. As used herein, porosity is the ratio of the pore volume (e.g., the total volume occupied by the pores in a component) to the total volume occupied by the component. As such, porosity is related to a material's density. The porosity of a component is also classified according to the size of the individual pores defined within the component. As used herein, pores include openings and/or passageways within the particle. Since the radius of a pore may be irregular (e.g., variably and non-uniform), a pore radius may reflect an average cross sectional area of a pore, as determined on the surface of the component in which the pore is present. In some embodiments the large porous refractory oxide support is alumina, e.g., aluminum oxide.

Classifications according to IUPAC based on pore size include micro, meso- and macroporosity components. A micropore component has pores less than about 20 angstroms (Å) in diameter. A mesopore component has pores of about 20 Å and 500 Å in diameter. A macropore component has pores greater than about 500 Å in diameter. In some embodiments, the porous refractory oxide support is macroporous.

In some embodiments, the porous refractory oxide support has pores with average pore radius ranging from about 250 to about 5,000 Å, preferably about 300 to about 5,000 Å, more preferably about 300 to about 1,000 Å, wherein at least 40% of the total pore volume of the large porous refractory oxide support is associated with pores of such average pore radius. Preferably, greater than or equal to about 50%, more preferably greater than or equal to about 80% of the pore volume of the porous refractory oxide support are associated with pores having an average radius of about 250 Å to about 5,000 Å. More preferred, greater than or equal to about 40%, preferably greater than or equal to about 50%, more preferably greater than or equal to about 80% of the pore volume is associated with pores having an average pore radius of about 300 Å to about 5,000 Å. Still more preferred, greater than or equal to about 40%, preferably greater than or equal to about 50%, more preferably greater than or equal to about 80% of the pore volume is associated with pores having an average pore radius of about 300 Å to about 1,000 Å. In some embodiments, the average pore radius only comprises pores in the range of about 50 angstroms to about 1,000 angstroms.

The porous refractory oxide support may have a total pore volume of about 0.5 milliliter per gram (ml/g) to about 3 ml/g, preferably about 1 ml/g to about 2.75 ml/g, more preferably about 1.75 ml/g to about 2.5 ml/g. Preferably within this range, the total pore volume of the porous refractory oxide support is greater than or equal to about 1.5 ml/g, more preferably greater than or equal to about 1.75 ml/g. In some embodiments, the total pore volume of a macroporous aluminum oxide support is preferably less than or equal to about 2.5 ml/g, more preferably less than or equal to about 2 ml/g. In some embodiments, the total pore volume was determined using mercury porosimetry.

The porous refractory oxide support may have a total pore area ranging from about 50 to about 200 square meter per gram (m²/g), or ranging from about 100 to about 200 m²/g, or ranging from about 150 to about 200 m²/g (e.g., at least about 50 m²/g, or at least about 100, or at least about 150 m²/g). In some embodiments, the total pore area is determined using mercury porosimetry.

The porous refractory oxide support may have a total intrusion volume of at least about 1.8 ml/g (e.g., about 1.8 ml/g or greater or about 1.9 ml/g or greater or about 2.0 ml/g or greater) such as about 1.8 ml/g to about 2.5 ml/g or about 1.9 to about 2.4 ml/g, or about 2.0 to about 2.3 ml/g.

The porous refractory oxide support may have a porosity of at least about 80%, more preferably of at least about 85%, most preferably of at least about 90%, such as a porosity of about 80% to about 98% or about 80% to about 95% or about 85% to about 95% based on the total volume.

High surface area refractory oxide supports, such as alumina support materials, also referred to as “gamma alumina” or “activated alumina,” typically exhibit a BET surface area in excess of 60 m²/g, often up to about 200 m²/g or higher. “BET surface area” has its usual meaning of referring to the Brunauer, Emmett, Teller method for determining surface area by N₂ adsorption. In one or more embodiments the BET surface area ranges from about 100 to about 150 m²/g.

Porous refractory oxide supports provide numerous advantages over currently used porous refractory oxide supports (i.e., supports that are not macroporous) when used in TWC catalyst compositions. For example, porous refractory oxide supports typically exhibit better hydrothermal stability compared to currently used porous refractory oxide supports used in TWC compositions. Currently used porous refractory oxide supports are supports that are either microporous or mesoporous comprising a pore volume of about less than 1 ml/g. Hydrothermal stability is important because the TWC catalyst is located downstream of and adjacent to the engine, where exhaust gas emission temperatures can easily reach up to about 1000° C. TWC catalysts including a porous refractory oxide support would be more resistant to thermal aging thereby exhibiting increased catalytic efficiency and longevity.

Porous refractory oxide supports are also beneficial because of their improved dispersion of the impregnated PGM component compared to conventional refractory oxide supports. Due to the increase in average pore radius of the pores (i.e., pores having an average pore radius in the range of about 50 angstroms to about 1,000 angstroms) the increased capillary action during incipient wetness impregnation allows for a more efficient dispersion of the PGM component into the pores of the support compared to impregnation of a currently used porous refractory oxide support using the same concentration of PGM component in solution. In such supports the dispersion of the PGM component is uneven and a portion of the PGM particles may crowd together.

Lastly, porous refractory oxide supports exhibit better mass transfer properties compared to currently used porous refractory oxide support. Mass transfer is an important measurement for the ability of gaseous molecules present in the exhaust gas stream (e.g., HC, CO, and NOx) to diffuse throughout the pores of the refractory oxide support and associate with the catalytic composition impregnated into the porous refractory oxide support. Likewise, improved diffusion of the gaseous products obtained as a result of HC, CO, and NOx conversion (e.g., nitrogen, carbon dioxide, and oxygen) exiting the porous refractory oxide support allows for improved trafficking of these molecules in and out of the support and thereby fosters the catalytic activity of such TWC catalyst compositions.

As used therein, “OSC” refers to an oxygen storage component, that exhibits an oxygen storage capability and often is an entity that has multi-valent oxidation states and can actively react with oxidants such as oxygen (O₂) or nitric oxides (NO₂) under oxidative conditions, or reacts with reductants such as carbon monoxide (CO), hydrocarbons (HC), or hydrogen (H₂) under reduction conditions. Certain exemplary OSCs are rare earth metal oxides, which refers to one or more oxides of scandium, yttrium, and the lanthanum series defined in the Periodic Table of Elements. Examples of suitable oxygen storage components include ceria and praseodymia and combinations thereof.

In some embodiments, the oxygen storage component includes ceria (Ce) in a form that is oxidized to Ce⁴⁺ under lean exhaust gas conditions wherein an excess amount of oxygen is present in the exhaust stream, and that releases oxygen as it is reduced to the Ce′ oxidation state when rich exhaust gas conditions are present. Ceria may also be used as an oxygen storage component in combination with other materials including, for example, zirconium (Zr), lanthanum (La), praseodymium (Pr), neodymium (Nd), niobium (Nb), platinum (Pt), palladium (Pd), rhodium (Rh), iridium (Tr), osmium (Os), ruthenium (Ru), tantalum (Ta), zirconium (Zr), yttrium (Y), nickel (Ni), manganese (Mn), iron (Fe) copper (Cu), silver (Ag), gold (Au), samarium (Sm), gadolinium (Gd), and combinations comprising at least one of the foregoing metals. Various oxides (e.g., the metal in combination with oxygen (O)) may also be used, including, for example, zirconium oxide (ZrO₂), titania (TiO₂), praseodymia (Pr₆O₁₁), yttria (Y₂O₃), neodynia (Nd₂O₃), lanthana (La₂O₃), gadolinium oxide (Gd₂O₃), or mixtures comprising at least one of the foregoing.

Such combinations may be referred to as mixed oxide composites. For example, a “ceria-zirconia composite” means a composite comprising ceria and zirconia, without specifying the amount of either component. Suitable ceria-zirconia composites include, but are not limited to, composites having a ceria content ranging from about 25% to about 95%, preferably from about 50% to about 90%, more preferably from about 60% to about 70% by weight of the total ceria-zirconia composite (e.g., at least about 25% or at least about 30% or at least about 40% ceria content).

### Substrate

According to one or more embodiments, the substrate for the composition of a TWC catalyst component may be constructed of any material typically used for preparing automotive catalysts and will typically comprise a metal or ceramic honeycomb structure. The substrate typically provides a plurality of wall surfaces upon which the coating composition is applied and adhered, thereby acting as a carrier substrate for the catalyst composition.

Exemplary metallic substrates include heat resistant metals and metal alloys, such as titanium and stainless steel as well as other alloys in which iron is a substantial or major component. Such alloys may contain one or more of nickel, chromium, and/or aluminum, and the total amount of these metals may advantageously comprise at least 15 wt. % of the alloy, e.g., 10-25 wt. % of chromium, 3-8 wt. % of aluminum, and up to 20 wt. % of nickel. The alloys may also contain small or trace amounts of one or more other metals, such as manganese, copper, vanadium, titanium and the like. The surface or the metal carriers may be oxidized at high temperatures, e.g., 1000° C. and higher, to form an oxide layer on the surface of the substrate, improving the corrosion resistance of the alloy and facilitating adhesion of the coating layer to the metal surface.

Ceramic materials used to construct the substrate may include any suitable refractory material, e.g., cordierite, mullite, cordierite-α alumina, silicon nitride, zircon mullite, spodumene, alumina-silica magnesia, zircon silicate, sillimanite, magnesium silicates, zircon, petalite, α alumina, aluminosilicates and the like.

Any suitable substrate may be employed, such as a monolithic flow-through substrate having a plurality of fine, parallel gas flow passages extending from an inlet to an outlet face of the substrate such that passages are open to fluid flow. The passages, which are essentially straight paths from the inlet to the outlet, are defined by walls on which the catalytic material is coated as a washcoat to form a coating so that the gases flowing through the passages contact the catalytic material. The flow passages of the monolithic substrate are thin-walled channels which can be of any suitable cross-sectional shape, such as trapezoidal, rectangular, square, sinusoidal, hexagonal, oval, circular, and the like. Such structures may contain from about 60 to about 1200 or more gas inlet openings (i.e., “cells”) per square inch of cross section (cpsi), more usually from about 300 to 600 cpsi. The wall thickness of flow-through substrates can vary, with a typical range being between 0.002 and 0.1 inches. A representative commercially-available flow-through substrate is a cordierite substrate having 400 cpsi and a wall thickness of 6 mil, or 600 cpsi and a wall thickness of 4 mil. However, it will be understood that the invention is not limited to a particular substrate type, material, or geometry.

In alternative embodiments, the substrate may be a wall-flow substrate, wherein each passage is blocked at one end of the substrate body with a currently used porous plug, with alternate passages blocked at opposite end-faces. This requires that gas flow through the porous walls of the wall-flow substrate to reach the exit. Such monolithic substrates may contain up to about 700 or more cpsi, such as about 100 to 400 cpsi and more typically about 200 to about 300 cpsi. The cross-sectional shape of the cells can vary as described above. Wall-flow substrates typically have a wall thickness between 0.002 and 0.1 inches. A representative commercially available wall-flow substrate is constructed from a porous cordierite, an example of which has 200 cpsi and 10 mil wall thickness or 300 cpsi with 8 mil wall thickness, and wall porosity between 45-65%. Other ceramic materials such as aluminum-titanate, silicon carbide and silicon nitride are also used a wall-flow filter substrates. However, it will be understood that the invention is not limited to a particular substrate type, material, or geometry. Note that where the substrate is a wall-flow substrate, the catalyst composition can permeate into the pore structure of the porous walls (i.e., partially or fully occluding the pore openings) in addition to being disposed on the surface of the walls.

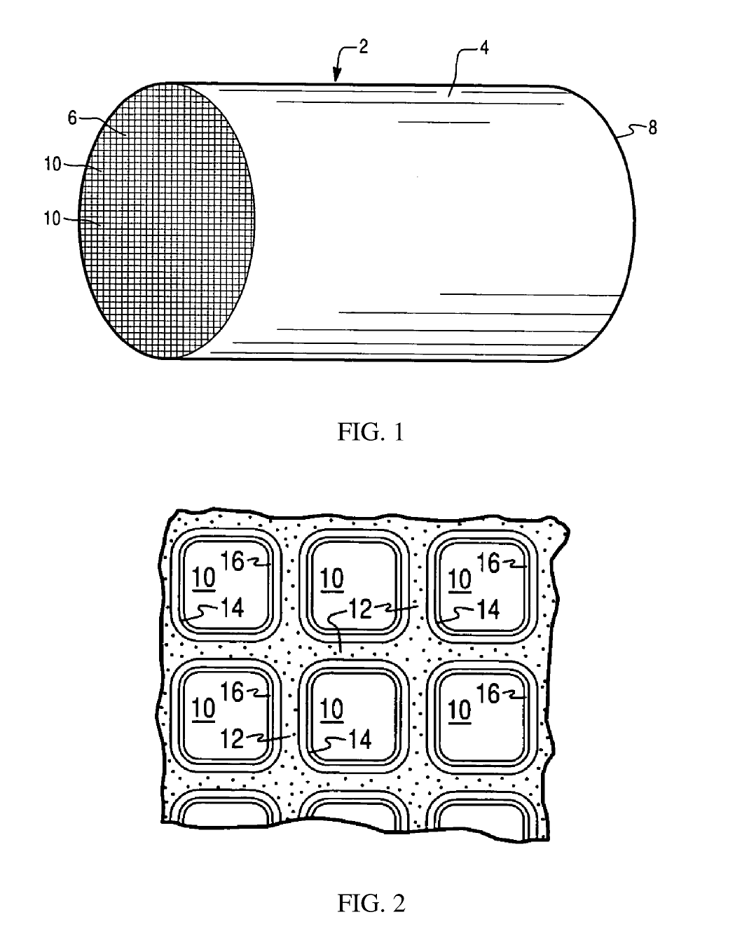

FIGS. 1 and 2 illustrate an exemplary substrate 2 in the form of a flow-through substrate coated with a washcoat composition, i.e., coating, as described herein. Referring to FIG. 1, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 2, flow passages 10 are formed by walls 12 and extend through carrier 2 from upstream end face 6 to downstream end face 8, the passages 10 being unobstructed so as to permit the flow of a fluid, e.g., a gas stream, longitudinally through carrier 2 via gas flow passages 10 thereof. As more easily seen in FIG. 2, walls 12 are so dimensioned and configured that gas flow passages 10 have a substantially regular polygonal shape. As shown, the coating composition can be applied in multiple, distinct layers if desired. In the illustrated embodiment, the coating consists of both a discrete bottom coating layer 14 adhered to the walls 12 of the carrier member and a second discrete top coating layer 16 coated over the bottom coating layer 14. The present invention can be practiced with one or more (e.g., 2, 3, or 4) coating layers and is not limited to the illustrated two-layer embodiment.

Alternatively, FIGS. 1 and 3 can illustrate an exemplary substrate 2 in the form a wall flow filter substrate coated with a washcoat composition, i.e., coating, as described herein. As seen in FIG. 3, the exemplary substrate 2 has a plurality of passages 52. The passages are tubularly enclosed by the internal walls 53 of the filter substrate. The substrate has an inlet end 54 and an outlet end 56. Alternate passages are plugged at the inlet end with inlet plugs 58, and at the outlet end with outlet plugs 60 to form opposing checkerboard patterns at the inlet 54 and outlet 56. A gas stream 62 enters through the unplugged channel inlet 64, is stopped by outlet plug 60 and diffuses through channel walls 53 (which are porous) to the outlet side 66. The gas cannot pass back to the inlet side of walls because of inlet plugs 58. The porous wall flow filter used in this invention is catalyzed in that the wall of said element has thereon or contained therein one or more catalytic materials. Catalytic materials may be present on the inlet side of the element wall alone, the outlet side alone, both the inlet and outlet sides, or the wall itself may consist all, or in part, of the catalytic material. This invention includes the use of one or more layers of catalytic material on the inlet and/or outlet walls of the element.

In describing the quantity of coating or catalytic metal components or other components of the composition, it is convenient to use units of weight of component per unit volume of catalyst substrate. Therefore, the units, grams per cubic inch (“g/in³”) and grams per cubic foot (“g/ft³”) are used herein to mean the weight of a component per volume of the support or substrate, including the volume of void spaces of the support substrate. Other units of weight per volume such as g/L are also sometimes used. For example, in some embodiments the loading of the PGM component on the porous refractory oxide support is preferably from about 0.1 to about 6 g/in³, more preferably from about 0.1 to about 5 g/in³. In another example, in some embodiments the loading of the PGM component onto the oxygen storage component is preferably from about 0.1 to about 6 g/in³, more preferably from about 2 to about 5 g/in³ and most preferably from about 3 to about 4 g/in³.

In some embodiments, the loading of the PGM component on the porous refractory oxide support or the oxygen storage component in each layer ranges from about 0.25 to about 1.5 g/in³.

The total loading of the catalyst composition on the carrier substrate, such as a monolithic flow-through substrate, is typically from about 0.5 to about 6 Win′, and more typically from about 1 to about 5 Win′. Total loading of the PGM component without support material (i.e., the Pt or Pd or combination thereof) is typically in the range of about 10 to about 200 g/ft³ for each individual substrate carrier.

It is noted that these weights per unit volume are typically calculated by weighing the catalyst substrate before and after treatment with the catalyst coating composition, and since the treatment process involves drying and calcining the catalyst substrate at high temperature, these weights represent an essentially solvent-free catalyst coating as essentially all of the water of the washcoat slurry, i.e., coating slurry, has been removed.

### Method of Making the Catalyst Composition

Preparation of the PGM-impregnated porous refractory oxide support or the PGM-impregnated oxygen storage component (OSC) typically comprises impregnating the porous refractory oxide support material or oxygen storage component (OSC) in particulate form with a PGM solution, such as a platinum solution or a palladium solution, or a combination thereof.

Multiple PGM components (e.g., platinum and palladium) can be impregnated at the same time or separately, and can be impregnated on the same support particles or separate support particles using an incipient wetness technique.

Incipient wetness impregnation techniques, also called capillary impregnation or dry impregnation are commonly used for the synthesis of heterogeneous materials, i.e., catalysts.

In general, the support is in contact with only enough solution of the impregnant (i.e., metal precursor dissolved in aqueous/organic solution) to fill the pores of the support. The volume of liquid needed to reach this stage of “incipient wetness” is usually determined by slowly adding small quantities of the solvent to a well stirred amount of support until the mixture turns slightly liquid. This weight volume ratio is them used to prepare a solution of the metal precursor salt having the appropriate concentration to give the desired metal loading.

Typically, a metal precursor is dissolved in an aqueous or organic solution and then the metal-containing solution is added to a catalyst support, containing the same pore volume as the volume of the solution that was added. Capillary action draws the solution into the pores of the support. Solution added in excess of the support pore volume causes the solution transport to change from a capillary action process to a diffusion process, which is much slower. The catalyst can then be dried and calcined to drive off the volatile components within the solution, depositing the metal on the catalyst surface. The maximum loading is limited by the solubility of the precursor in the solution. The concentration profile of the impregnated material depends on the mass transfer conditions within the pores during impregnation and drying.

The support particles are typically dry enough to absorb substantially all of the solution to form a moist solid. Aqueous solutions of water soluble compounds or complexes of the PGM component are typically utilized, such as palladium or platinum nitrate, tetraammine palladium or platinum nitrate, or tetraammine palladium or platinum acetate. Following treatment of the support particles with the PGM solution, the particles are dried, such as by heat treating the particles at elevated temperature (e.g., 100-150° C.) for a period of time (e.g., 1-3 hours), and then calcining to convert the PGM components to a more catalytically active form. An exemplary calcination process involves heat treatment in air at a temperature of about 400 to about 550° C. for about 1- to about 3 hours. The above process can be repeated as needed to reach the desired level of PGM impregnation. In some embodiments, the calcining is replaced with precipitation of the PGM impregnated porous refractory oxide support. The resulting material can be stored as a dry powder.

The incipient wetness using a PGM component in solution may range from about 90% to about 105%, preferably from about 80% to about 100% by volume based on the total volume of solvent. In some embodiments, the PGM component is Pd. In some embodiments, the PGM component is a combination of Pt and Pd.

The PGM component (e.g., palladium) may be loaded onto the support material, wherein the loading is sufficient for the PGM component to be active for its respective function, e.g., carbon monoxide (CO) oxidation, hydrocarbon oxidation reactions and NOx reduction. For example, as mentioned previously the loading of the PGM component on the porous refractory oxide support and/or oxygen storage component is preferably from about 0.1 to about 6 g/in³, more preferably from about 2 to about 5 g/in³ and most preferably from about 3 to about 4 g/in³.

### Substrate Coating Process

The above-noted catalyst composition, in the form of carrier particles containing PGM-impregnated porous refractory oxide support, is mixed with water to form a slurry for purposes of coating a catalyst carrier substrate, such as a honeycomb-type substrate. In some embodiments, a PGM-impregnated oxygen storage component is added to the slurry containing the PGM impregnated porous refractory oxide support at a later time. In some embodiments, a slurry is formed with the PGM-impregnated porous refractory oxide support and PGM-impregnated oxygen storage component mixed together with water at the same time. Water-soluble compounds or water-dispersible compounds or complexes of the metal component may be used as long as the liquid medium used to impregnate or deposit the metal component into the support particles does not adversely react with the support or its compound or its complex or other components which may be present in the catalyst composition and is capable of being removed from the metal component by volatilization or decomposition upon heating and/or application of a vacuum.

In addition to the catalyst particles, the slurry may optionally contain alumina as a binder, hydrocarbon (HC) storage components (e.g., zeolite), water-soluble or water-dispersible stabilizers (e.g., barium acetate), promoters (e.g., lanthanum nitrate), associative thickeners, and/or surfactants (including anionic, cationic, non-ionic or amphoteric surfactants).

In one or more embodiments, the slurry is acidic, having, for example, a pH of about 2 to about 7. A typical pH range for the slurry is about 4 to about 5. The pH of the slurry may be lowered by the addition of an adequate amount of an inorganic or an organic acid to the slurry. Combinations of both can be used when compatibility of acid and raw materials is considered. Inorganic acids include, but are not limited to, nitric acid. Organic acids include, but are not limited to, acetic, propionic, oxalic, malonic, succinic, glutamic, adipic, maleic, fumaric, phthalic, tartaric, citric acid and the like. Thereafter, if desired, water-soluble or water-dispersible compounds or stabilizers, e.g., barium acetate, and a promoter, e.g., lanthanum nitrate, may be added to the slurry

Optionally, as noted above, the slurry may contain one or more hydrocarbon (HC) storage component for the adsorption of hydrocarbons (HC). Any known hydrocarbon storage material can be used, e.g., a micro-porous material such as a zeolite or zeolite-like material. Preferably, the hydrocarbon storage material is a zeolite. The zeolite can be a natural or synthetic zeolite such as faujasite, chabazite, clinoptilolite, mordenite, silicalite, zeolite X, zeolite Y, ultrastable zeolite Y, ZSM-5 zeolite, offretite, or a beta zeolite. Preferred zeolite adsorbent materials have a high silica to alumina ratio. The zeolites may have a silica/alumina molar ratio of from at least about 25:1, preferably at least about 50:1, with useful ranges of from about 25:1 to 1000:1, 50:1 to 500:1, as well as about 25:1 to 300:1. Preferred zeolites include ZSM, Y and beta zeolites. A particularly preferred adsorbent may comprises a beta zeolite of the type disclosed in U.S. Pat. No. 6,171,556, incorporated herein by reference in its entirety. When present, zeolite or other HC storage components are typically used in an amount of about 0.05 Win′ to about 1 Win′.

When present, the alumina binder is typically used in an amount of about 0.05 ml/g to about 1 ml/g. The alumina binder can be, for example, boehmite, gamma-alumina, or delta/theta alumina.

The slurry can be milled to enhance mixing of the particles and formation of a homogenous material. The milling can be accomplished in a ball mill, continuous mill, or other similar equipment, and the solids content of the slurry may be, e.g., about 20-60 wt. %, more particularly about 30-40 wt. %. In one embodiment, the post-milling slurry is characterized by a D90 particle size of about 10 to about 40 microns, preferably 10 to about 25 microns, more preferably about 10 to about 20 microns (i.e., at least less than 40 microns, or at least less than 25 microns, or at least less than 20 microns). The D90 is defined as the particle size at which 90% of the particles have a finer particle size.

The slurry is then coated onto the catalyst substrate using a coating technique known in the art. In one embodiment, the catalyst substrate is dipped one or more times in the slurry or otherwise coated with the slurry such that there will be deposited on the catalyst substrate the desired loading of the support, e.g., about 0.5 to about 2.5 g/in³ per dip. Thereafter, the coated substrate is dried at an elevated temperature (e.g., 100-150° C.) for a period of time (e.g., 1-3 hours) and then calcined by heating, e.g., at 400-600° C., typically for about 10 minutes to about 3 hours.

If a PGM-impregnated OSC is present, delivery of such OSC to a coating layer can be achieved by the use of, for example, mixed oxide composites. For example, PGM-impregnated ceria can be delivered as a composite of mixed oxide of cerium and zirconium, and/or a mixed oxide of cerium, zirconium, and neodymium. For example, praseodymia can be delivered as a mixed oxide composite of praseodymium and zirconium, and/or a mixed oxide composite of praseodymium, cerium, lanthanum, yttrium, zirconium, and neodymium.

After calcining, the catalyst loading obtained by the above described coating technique can be determined through calculation of the difference in coated and uncoated weights of the substrate. As will be apparent to those of skill in the art, the catalyst loading can be modified by altering the slurry rheology. In addition, the coating/drying/calcining process to generate a coating can be repeated as needed to build the coating to the desired loading level or thickness, meaning more than one coating may be applied.

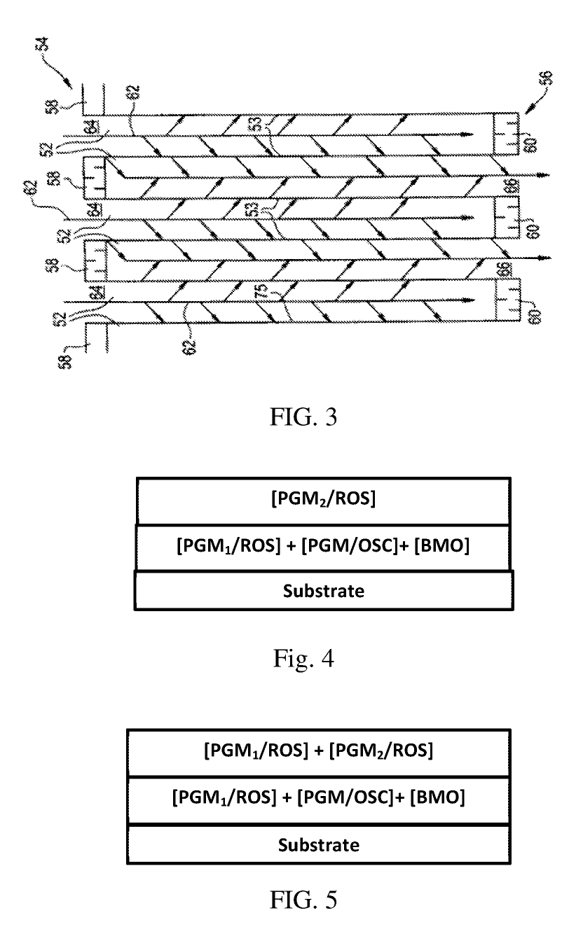

Relevant designs for the catalyst articles disclosed herein include zoned and layered selective catalytic reduction articles. In some embodiments, the catalyst composition can be applied as a single layer or in multiple layers. In one embodiment, the catalyst composition is applied in a single layer (e.g., only layer 16 of FIG. 2). In one embodiment, the catalyst composition is applied in multiple layers with each layer having a different or the same composition (e.g., layer 14 and 16 of FIG. 2). For example, the first (bottom) layer (FIG. 4) can comprise a catalyst composition of the invention including a combination of a first PGM impregnated porous refractory oxide support (ROS) (e.g., Pd/alumina), a PGM impregnated oxygen storage component (OSC) (e.g., Pd/ceria-zirconia composite), and base metal oxide(s) (BMO) and the second (top) layer can comprise a catalyst composition of the invention including a second PGM impregnated ROS (Rh/ROS). In another example, the bottom layer (e.g., FIG. 5) can comprise a catalyst composition of the invention including combination of a first PGM impregnated porous refractory oxide support (ROS) (e.g., Pd/alumina), a PGM impregnated oxygen storage component (OSC) (e.g., Pd/ceria-zirconia composite), and base metal oxide(s) (BMO) and the top layer can comprise a catalyst composition of the invention including a combination of the first PGM impregnated ROS (e.g., Pd/alumina) and a second PGM impregnated ROS (Rh/ROS).

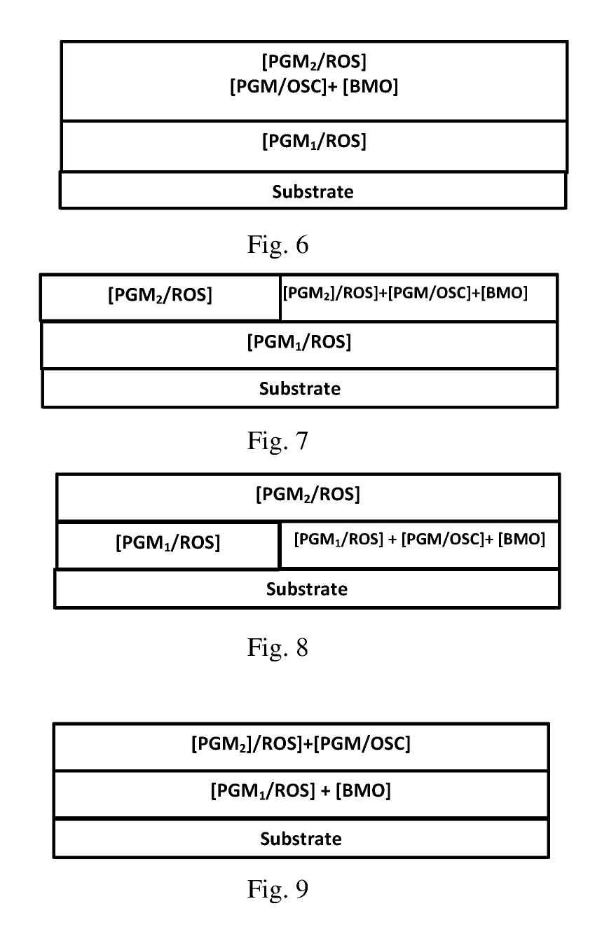

Yet, in another example, the bottom layer (e.g., FIG. 6) can comprise a catalyst composition of the invention including having a first PGM impregnated refractory oxide support (ROS) (e.g., Rh/ROS) and the top layer can comprise a catalyst composition of the invention including a combination of a second PGM impregnated porous ROS (e.g., Pd/alumina), a PGM impregnated OSC (Pd/ceria-zirconia composite), and base metal oxide(s).

Yet, in another example, the bottom layer (e.g., FIG. 9) can comprise a catalyst composition of the invention including a first PGM impregnated porous refractory oxide support (ROS) (e.g., Pd/alumina) and base metal oxide(s) (BMO) and the top layer can comprise a catalyst composition of the invention including a combination of a second PGM impregnated ROS (e.g., Rh/ROS) and a PGM impregnated OSC (e.g., Pd/ceria-zirconia composite).

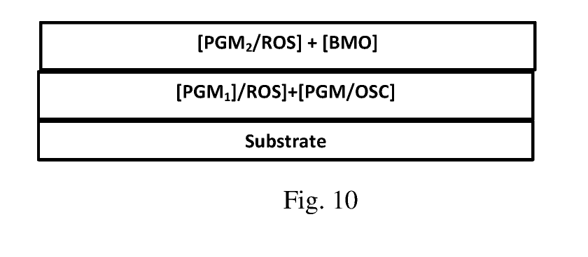

In another example, the bottom layer (e.g., FIG. 10) can comprise a catalyst composition of the invention including combination of a first PGM impregnated refractory oxide support (ROS) (e.g., Rh/ROS) and a PGM impregnated oxygen storage component (OSC) (e.g., Pd/ceria-zirconia composite) and the top layer (e.g., FIG. 10) can comprise a catalyst composition of the invention including a combination of a second PGM impregnated porous refractory oxide support (ROS) (e.g., Pd/alumina) and base metal oxide(s) (BMO).

In one or more embodiments, the catalyst system comprises a layered catalytic article, wherein at least one layer is made of two zones, an upstream zone and a downstream zone.

In one or more embodiments, the layered catalyst article is in an axially zoned configuration wherein the catalyst composition comprising the upstream zone is coated on the same substrate upstream of the catalyst composition comprising the downstream zone.

According to one or more embodiments, the amount of catalyst composition comprising the upstream zone is coated onto such substrate may be in the range of about 1% to about 95%, more preferably, about 25% to about 75%, even more preferably about 30% to about 65% of the axial length of the substrate.

Referring to FIG. 7, an exemplary embodiment of an axially zoned system is shown. The layered catalyst article is shown, wherein the first layer (bottom layer) comprises a PGM impregnated refractory oxide material (e.g., Rh/ROS) and the second (top) layer is in an axially zoned arrangement where a second PGM impregnated porous ROS (e.g., Pd/alumina) is in the upstream zone and a combination of the second PGM impregnated porous ROS (e.g., Pd/alumina), PGM impregnated OSC (Pd/ceria zirconia-composite), and base metal oxide(s) (BMO) is in the downstream zone.

Another example is shown in FIG. 8, wherein the first layer (bottom layer) is in an axially zoned arrangement where a first PGM impregnated porous ROS (e.g., Pd/alumina) is in the upstream zone and a combination of the second PGM impregnated porous ROS (e.g., Pd/alumina), PGM impregnated OSC (Pd/ceria zirconia-composite), and base metal oxide(s) (BMO) is in the downstream zone and the second (top) layer comprises a second PGM impregnated refractory oxide material (e.g., Rh/ROS).

The relative amount of the catalyst composition(s) in each layer can vary, with an exemplary dual layer coating comprising about 10-90% by weight of the total weight of catalyst composition including a PGM component in the bottom layer (adjacent to the substrate surface) and about 10-90% by weight of the total weight of the catalyst composition in the top layer.

### Method of Hydrocarbon (HC), Carbon Monoxide (CO), and Nitrogen Oxides (NOx) Conversion

In general, hydrocarbons, carbon monoxide, and nitrogen oxides present in the exhaust gas stream of a gasoline or diesel engine can be converted to carbon dioxide, nitrogen, oxygen and water according to the equations shown below:

2NOₓ→xO₂+N₂

2CO+O₂→2CO₂

CₓH₂ₓ₊₂+[(3x+1)/2]O₂→xCO₂+(x+1)H₂O

Typically, hydrocarbons present in engine exhaust gas stream comprise C₁-C₆ hydrocarbons (i.e., lower hydrocarbons), although higher hydrocarbons (greater than C₆) can also be detected.

As such aspects of the current invention are directed towards a method for partially converting amounts of HC, CO, and NOx in an exhaust gas stream comprising contacting the gas stream with a catalyst composition as described by the enclosed embodiments, for a time and temperature sufficient to partially convert amounts of HC, CO, and NOx in the exhaust gas stream.

In some embodiment, the catalyst composition converts hydrocarbons to carbon dioxide and water. In some embodiments, the catalyst composition converts at least about 60%, or at least about 70%, or at least about 75%, or at least about 80%, or at least about 90%, or at least about 95% of the amount of hydrocarbons present in the exhaust gas stream prior to contact with the catalyst composition.

In another embodiment, the catalyst composition converts carbon monoxide to carbon dioxide. In some embodiments, the catalyst composition converts at least about 60%, or at least about 70%, or at least about 75%, or at least about 80%, or at least about 90%, or at least about 95% of the amount of carbon monoxide present in the exhaust gas stream prior to contact with the catalyst composition.

In another embodiment, the catalyst composition converts nitrogen oxides to nitrogen and oxygen. In some embodiments, the catalyst composition converts at least about 60%, or at least about 70%, or at least about 75%, or at least about 80%, or at least about 90%, or at least about 95% of the amount of nitrogen oxides present in the exhaust gas stream prior to contact with the catalyst composition.

In another embodiment, the catalyst composition converts at least about 60%, or at least about 70%, or at least about 75%, or at least about 80%, or at least about 90%, or at least about 95% of the total amount of hydrocarbons, carbon dioxide, and nitrogen oxides combined present in the exhaust gas stream prior to contact with the catalyst composition.

### EXAMPLES

### Example 1: Determination of the Pore Radius Distribution and Other Parameters of Comparative Alumina Supports A-C and Porous Alumina Support D

Mercury porosimetry experiments were used to measure total intrusion volume, average pore radius, and % porosity. Mercury porosimetry is an analytical technique used to determine various quantifiable aspects of a material's porous nature, such as pore diameter, total pore volume, and surface area. The technique involves the intrusion of liquid mercury at high pressure into a material through the use of a porosimeter. The pore size can be determined based on the external pressure needed to force the liquid into a pore against the opposing force of the liquid's surface tension.

Mercury porosimetry measures pores in the meso and macro porous range from about 20 Å to over 100,000 Å. However, the pores in the mesoporous range up to 10,000 Å are most significant for catalysis. The mesopores are where most metals are deposited and where, in high surface area materials, most reactions take place. Higher mesoporosity leads to better diffusion properties, which leads to higher activity and better selectivity.

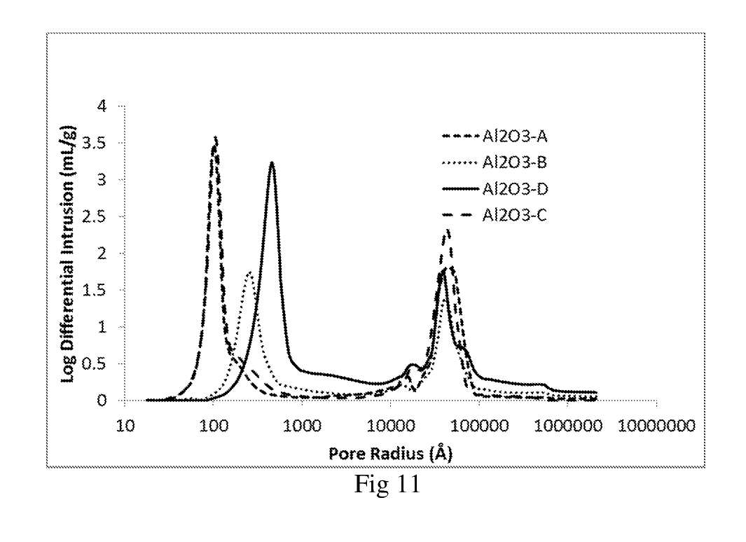

Before the measurements begin, the sample may be evacuated to remove air and residual moisture or other liquids from the pores system. A complete evacuation is desirable to avoid any possible air pockets and contamination issues. The sample is then filled with mercury as the entire system is still under reduced pressure. Slowly increasing the overall pressure then allows mercury to penetrate the largest pores in the sample or any void spaces between sample pieces first. Such initial measurements are of less interest because the large pores present in the material and the void spaces between particles do not contribute to the catalytic properties of the material. For example, in FIG. 11 the signals between 10,000 and 100,000 angstroms show initial measurements of large pores and void spaces between particles in these samples.

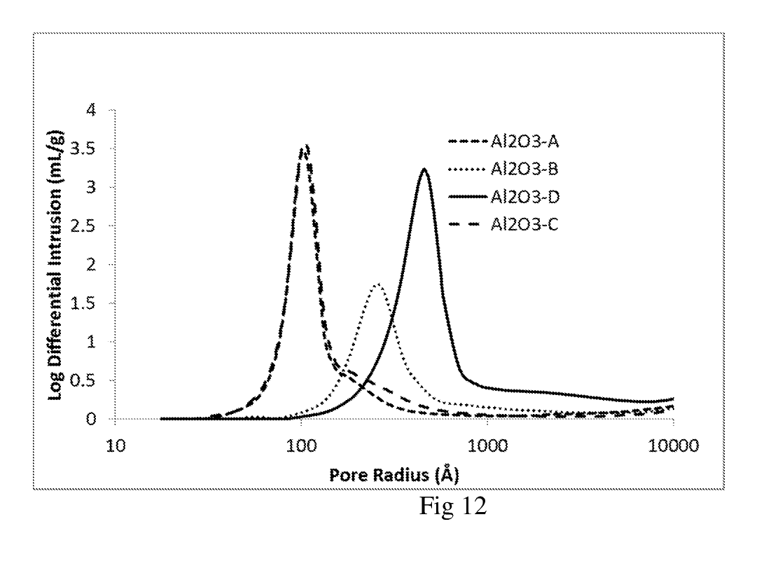

As the pressure continues to increase mercury is able to penetrate pores in the range of about 50 angstroms to about 1,000 angstroms and produce signals for each sample as is shown in FIGS. 11 and 12. These measurements define regions of the material, which contributes to catalysis and therefore are of interest. Table 1 summarizes the data obtained from the mercury porosimetry experiments, wherein the average pore radius only comprises data obtained in each sample for pores in the range of about 50 angstroms to about 1,000 angstroms and was determined using two different methods.

TABLE 1
Physical properties of alumina measured by mercury porosimetry.

| | | | Average | | |
|---|---|---|---|---|---|
| | Total | Average | Pore | Total | |
| | Pore | Pore | Radius | Intrusion | |
| Alumina | Area | Radius | (2V/A), | Volume | Porosity |
| Supports | (m²/g) | (Å)* | (Å)** | (mL/g) | (%) |
| Al₂O₃-A | 165.1 | 100 | 208 | 1.7 | 82.5 |
| Al₂O₃-B | 51.0 | 233 | 511 | 1.3 | 69.5 |
| Al₂O₃-C | 182 | 101 | 202 | 1.8 | 63.0 |
| Al₂O₃-D | 182.3 | 400 | 827 | 2.2 | 92.3 |

*Methods used to determine average pore radius are based on pore area alone (2-dimensional calculations).
**Methods used to determine average pore radius are based on pore volume, e.g. Barrett, Joyner, and Halenda Method (BHJ) (3-dimensional calculations).

### Example 2: General Procedure for the Preparation of Catalytic Articles Containing Palladium on Comparative Alumina Support A-C and Porous Alumina Support D

A solution was prepared using Pd nitrate. The solution was divided equally into two parts. The first part of the Pd nitrate solution is used to impregnate into an alumina support (e.g., Al₂O₃-A) and the second part of the Pd nitrate solution is used to impregnate into an oxygen storage material, e.g., a ceria/zirconia composite (CeO₂/ZrO₂ with a ceria content of 40%) using incipient wetness techniques. The impregnated supports, Pd/alumina support and Pd/OSC support are individually calcined at 550° C. for 2 hours.

Next a slurry was prepared by mixing the calcined Pd on alumina with water and acetic acid. The mixture was milled to a particle size distribution of 90% less than 25 μm. After milling the Zr acetate (0.5 g/in³ based on calcined Zr oxide) and Ba sulfate (0.15 g/in³ based on calcined BaO) were added and the pH was adjusted to 4.2 using acetic acid.

The calcined Pd/OSC support was added to the alumina slurry and ball milled further to a particle size distribution of 90% less than 18 μm.

The slurry was coated onto a monolithic substrate (600 cells/in^{t} and 4 mills wall thickness) having a 4.16″ diameter and 1.5″ in length. The amount of alumina support in the final calcined coating loading will be 1 g/in³ with a Pd concentration of 1.6% (amount of palladium on the alumina support based on the total amount of calcined alumina support impregnated with Pd).

The wash coated parts were calcined at 550° C. in air for 2 hours. The finished coated catalyst will contain 1.7 g/in³ with a Pd loading based on calcined part of 0.94% (total % of Pd on the monolith based on the weight of the coated monolith). The dimensions were adjusted to core pieces having 1″ diameter and 1.5″ length in order to be used in lab reactor testing. The total amount of Pd calculated based on the volume of the monolithic substrate is 55 g/ft³ (or 0.0318 g/in³).

The above procedure was repeated using each alumina support B-D.

### Example 3: Evaluation of Catalytic Articles Containing Pd Modified Comparative Alumina Support A-C and Porous Alumina Support D for Emission Performance

The catalyst compositions coated on monolithic substrates were aged under cyclic aging conditions at 950° C. for 5 hours, wherein the cycling altered between lean, stoichiometric and rich conditions 15 minutes each.

After aging the catalyst composition coated monolithic substrates were tested in a lab reactor simulating real vehicle driving cycle using the New European Driving Cycle (NEDC).

Summary of the testing results are provided in Tables 2 and 3. Table 2 shows the amount of residual HC, CO, and NOx remaining as a percentage of the initial amount of HC, CO and NOx present in the exhaust gas stream prior to exposure to the catalyst coated monolithic substrate. Lower percent residual indicates better performance for the individual catalyst composition. The catalyst composition Al₂O₃-D showed lower residual amounts for the HC, CO, and NOx present after exposure of the exhaust gas emissions than comparative catalysts Al₂O₃-A, Al₂O₃—B, and Al₂O₃—C. This may be due to the improved pore diffusion present within the coating of the catalyst composition Al₂O₃-D.

TABLE 2
Percent Residual of HC, CO, and NOx.

| Pd-supported | % Residual | | |
|---|---|---|---|
| Catalyst | HC, % | CO, % | NOx, % |
| Al₂O₃-A | 7.5 | 14.3 | 3.9 |
| Al₂O₃-B | 7.4 | 13.8 | 3.9 |
| Al₂O₃-C | 8 | 13.5 | 4.5 |
| Al₂O₃-D | 7.2 | 12.9 | 3.6 |

The results also are provided in cumulative emission measurements, which are the total amounts measured throughout the entire testing period. Lower values measured during the testing time indicate better emission catalyst performance for the individual catalyst composition. The catalyst composition Al₂O₃-D shows lower cumulative amounts of HC, CO, and NOx present in the exhaust gas after exposure to the catalyst compared to catalysts Al₂O₃-A, Al₂O₃—B, and Al₂O₃—C.

TABLE 3
Cumulative HC, CO, & NOx emission (g/L of catalyst)

| Pd-supported | Emission, g/liter-catalyst | | |
|---|---|---|---|
| Catalyst | HC | CO | NOx |
| Al₂O₃-A | 2.36 | 15.4 | 1.46 |
| Al₂O₃-B | 2.36 | 15.1 | 1.46 |
| Al₂O₃-C | 2.44 | 14.4 | 1.75 |
| Al₂O₃-D | 2.24 | 13.97 | 1.37 |

1. A catalyst composition comprising:
a platinum group metal component impregnated into a porous refractory oxide support, wherein the porous refractory oxide support has an average pore radius ranging from about 250 Å to about 5,000 Å, a total intrusion volume of at least about 1.8 ml/g, and a porosity of at least about 80%.

2. The catalyst composition of claim 1, wherein the porous refractory oxide support has a total pore area of at least about 50 m²/g, or comprises at least 90% by weight alumina based on the total weight of the porous refractory oxide support, or comprises stabilized alumina.

3. The catalyst composition of claim 1, wherein the platinum group metal component is palladium, platinum, a combination of palladium and platinum, or a combination of palladium and platinum, wherein the platinum is present in about 10% to about 80% by weight based on the total platinum group metal component.

4.-6. (canceled)

7. The catalyst composition of claim 1, further comprising a platinum group metal impregnated into an oxygen storage component.

8. The catalyst composition of claim 7, wherein the oxygen storage component comprises ceria, or a ceria-zirconia composite, or a ceria-zirconia composite comprises at least 10% by weight ceria, based on the total weight of the ceria-zirconia composite.

9.-10. (canceled)

11. A catalyst article comprising a catalyst substrate having a plurality of channels adapted for gas flow, each channel having a coating dispersed therein, the coating comprising at least one catalyst composition according to claim 1.

12. The catalyst article of claim 11, wherein the catalyst substrate is a metal or ceramic honeycomb.

13.-14. (canceled)

15. The catalyst article of claim 11, wherein the coating comprises a first layer comprising a first catalyst component in the form of the catalyst composition according to claim 1, optionally in combination with an additional catalyst component selected from the group consisting of a second PGM component impregnated into a second refractory oxide support, a base metal oxide, or a combination thereof, and a second layer comprising rhodium impregnated on a third refractory oxide support.

16. The catalyst article of claim 15, wherein at least one layer comprises a loading of PGM component impregnated into a porous refractory oxide component ranging from about 0.25 to about 1.5 g/in³.

17. The catalyst article of claim 15, wherein the PGM component in the first catalyst component is palladium and the porous refractory oxide support comprises alumina.

18. The catalyst article of claim 15, wherein the second layer further comprises a PGM component impregnated on an OSC.

19. The catalyst article of claim 15, wherein at least one of the first and second layers is zoned into an upstream zone and a downstream zone.

20. The catalyst article of claim 19, wherein the upstream zone comprises the first catalyst component.

21. The catalyst article of claim 20, wherein the downstream zone comprises one or more of a base metal oxide and a PGM component impregnated on an OSC.

22. (canceled)

23. A method for reducing CO, HC, and NOx levels in an exhaust gas comprising contacting the gas with a catalyst for a time and temperature sufficient to reduce the levels of HC, CO, and NOx in the gas, wherein the catalyst comprises a catalyst composition according to claim 1.

24. The method of claim 23, wherein the CO, HC, and NOx levels present in the exhaust gas stream are reduced by at least 50% compared to the CO, HC, and NOx levels in exhaust gas stream prior to contact with the catalyst.

25. A method of making a catalyst article according to claim 11 comprising:
a. impregnating a porous refractory oxide support with a salt of a platinum group metal component to form a platinum group metal (PGM) impregnated porous refractory oxide support;
b. calcining the PGM impregnated porous refractory oxide support;
c. preparing a slurry by mixing the calcined PGM impregnated porous refractory oxide support in an aqueous solution;
d. coating the slurry onto a monolithic substrate; and
e. calcining the coated monolithic substrate to obtain the catalyst article.

26. The method of claim 25, further comprising impregnating an oxygen storage component with a salt of a platinum group metal component to form a platinum group metal (PGM) impregnated oxygen storage component, calcining the platinum group metal (PGM) impregnated oxygen storage component, and adding the calcined platinum group metal (PGM) impregnated oxygen storage component to the slurry.

27.-28. (canceled)

29. The method of claim 25, wherein the PGM is palladium and the refractory metal oxide comprises alumina, and the monolithic substrate is a metal or ceramic honeycomb.

30.-31. (canceled)

32. An exhaust gas treatment system comprising the catalyst article of claim 1 disposed downstream from an internal combustion engine that is a gasoline or a diesel engine.

33. (canceled)
